(19) United States
(12) Patent Application Publication
(10) Pub. No.: US 2013/0101781 A1
(43) Pub. Date: Apr. 25, 2013

(54) WOVEN AND KNITTED FABRICS WITH IMPROVED PROPERTIES AND CORE SPUN YARNS FOR PRODUCING THE SAME

(71) Applicant: Bestkey Textiles Limited, Shenzhen (CN)

(72) Inventors: Ivy Sau Chun LEE, Hong Kong (HK); Michael Xiao Li WANG, Shenzhen, Guangdong (CN); Frances WU, Hong Kong (HK); John Ying Bun WU, Hong Kong (HK)

(73) Assignee: BESTKEY TEXTILES LIMITED, Shenzhen (CN)

(21) Appl. No.: 13/655,422

(22) Filed: Oct. 18, 2012

Related U.S. Application Data
(60) Provisional application No. 61/550,464, filed on Oct. 24, 2011.

(51) Int. Cl. B32B 5/16; D03D 15/00; D04B 21/14; A47G 9/02; A41B 1/00; A41D 1/06; A41D 1/02; A41D 1/00; D02G 3/36; D04B 1/16

(52) U.S. Cl. 428/91; 428/373; 428/221; 442/191; 442/308; 2/69; 2/227; 2/93; 2/228; 5/495; 5/490

(57) ABSTRACT

A woven or knitted fabric with improved properties is formed of core spun yarns each including a (i) core yarn of polyester filaments, mechanical stretch polyester filaments, fire retardant polyester filaments, spandex filaments, high strength polyester filaments, nylon filaments, mechanical stretch nylon filaments, kevlar filaments, polypropylene filaments or a combination thereof; and (ii) a wrapper of cotton staple fibers, polyester staple fibers, rayon staple fibers, modal staple fibers, fire retardant staple fibers or a blend thereof. The fabric may be produced by ring spun, open-end or vortex. The fabric may be produced by different weaving and knitting methods. Regular yarns are mixed in the fabric.

### CROSS-REFERENCE TO RELATED APPLICATIONS

This application claims priority of U.S. provisional patent application No. 61/550,464 filed on Oct. 24, 2011, the entire content of which is hereby incorporated by reference.

### FIELD OF THE TECHNOLOGY

The present application relates to woven and knitted fabrics with improved tensile and tear strength properties, improved abrasion resistance properties, and natural and permanent wrinkle resistance properties. The present application also relates to core spun yarns for producing the woven and knitted fabrics with the improved properties.

### BACKGROUND

In order to increase tensile and tear strength, heavier fabrics with thicker and heavier yarns are usually utilized. These fabrics are thicker and heavier to meet the strength requirements. As a result, these fabrics tend to cause much discomfort to the wearer of the apparel, particularly in summer months.

The wrinkle resistant properties of a fabric are normally achieved with the application of resins containing, among other chemicals, formaldehyde and then curing by heat. However, the rating of wrinkle resistance will deteriorate as the apparel is repeatedly laundered. Furthermore, formaldehyde has been classified by the National Institutes of Health as being a carcinogen.

In order to increase abrasion resistance, heavier fabrics with thicker and heavier yarns are also utilized. These fabrics are thicker and heavier to meet the requirements. Again, as a result, these fabrics tend to cause much discomfort to the wearer of the apparel, particularly in the summer months.

Furthermore, the cost of these thicker and heavier fabrics is necessarily increased due to the use of more materials.

Hence, there is a need to produce woven and knitted fabrics with improved properties.

The above description of the background is provided to aid in understanding woven/knitted fabrics and core spun yarns, but is not admitted to describe or constitute pertinent prior art to the woven/knitted fabrics and core spun yarns disclosed in the present application, or consider any cited documents as material to the patentability of the claims of the present application.

### SUMMARY

According to one aspect, there is provided a core spun yarn including a core yarn and a wrapper wrapping around the core yarn. The core yarn includes a core material selected from the group consisting of polyester filament yarn, mechanical stretch polyester filament yarn, fire retardant polyester filament yarn, spandex filament yarn, high strength polyester filament yarn, nylon filament yarn, mechanical stretch nylon filament yarn, kevlar filament yarn, polypropylene filament yarn and combinations thereof. The wrapper includes a wrap material selected from the group consisting of 100% cotton staple fibers, polyester cotton blended staple fibers, 100% polyester staple fibers, 100% rayon staple fibers, 100% modal staple fibers, 100% fire retardant staple fibers, polyester rayon blended staple fibers and cotton rayon blended staple fibers and blends thereof.

According to another aspect, there is provided a fabric made of a core spun yarn having a core yarn and a wrapper wrapping around the core yarn. The core yarn includes a core material selected from the group consisting of polyester filament yarn, mechanical stretch polyester filament yarn, fire retardant polyester filament yarn, spandex filament yarn, high strength polyester filament yarn, nylon filament yarn, mechanical stretch nylon filament yarn, kevlar filament yarn, polypropylene filament yarn and combinations thereof. The wrapper includes a wrap material selected from the group consisting of 100% cotton staple fibers, polyester cotton blended staple fibers, 100% polyester staple fibers, 100% rayon staple fibers, 100% modal staple fibers, 100% fire retardant staple fibers, polyester rayon blended staple fibers and cotton rayon blended staple fibers and blends thereof.

In one embodiment, the fabric may further include a regular non-core yarn. The fabric may be formed with a mixture of the core spun yarns and the regular non-core yarns.

In one embodiment, the ratio of core spun yarns to regular non-core yarns can be one core spun yarn to one or more regular non-core yarns.

In one embodiment, the fabric may have a weaving configuration selected from the group consisting of poplin weave, poplin rip stop weave, left hand twill 2:1 weave, left hand twill 2:2 weave, left hand twill 3:1 weave, right hand twill 2:1 weave, right hand twill 2:2 weave, right hand twill 3:1 weave, left hand sateen 4:1 weave, right hand sateen 4:1 weave, canvas 1:1 weave, canvas 2:2 weave, oxford 2:2 double ply weave, cavalry weave, dobby weave, jacquard weave, corduroy weave and flannel weave.

In one embodiment, the fabric may have a weft knit configuration selected from the group consisting of jersey, rib 1×1, rib 2×1, rib 2×2, rib 3×3, single pique, double pique, fleece, French terry, interlock, feeder stripe, engineering stripe, dobby and jacquard.

In one embodiment, the fabric may have a warp knit configuration selected from the group consisting of tricot and rachel.

In one embodiment, the fabric can be produced by core spun yarns formed by a core sheath selected from the group consisting of ring spun core sheath, open-end core sheath or vortex core sheath.

According to yet another aspect, there is provided an article of apparel made of the fabric of the present application. The article of apparel may be selected from T shirts, polo shirts, knit shirts, knit shorts, knit pants, knit jackets, woven shirts, woven pants, woven jackets, denim jeans, denim shirts, denim jackets, chambray shirts, yarn dyed shirts, yarn dyed shorts, yarn dyed pants, bed sheets and pillow cases.

In one embodiment, the core material includes polyester filament yarn of approximately 57D overall in diameter, constituted by 48 strands of 1.2D filaments. The core spun yarn is produced by wrapping the wrap material around the core material utilizing a ring spin core spun machine. The wrap material includes polyester staple fiber of 1.5D with 38 mm staple length blended with cotton fiber in a ratio of 74.1% poly/25.9% cotton. The weaving configuration is 3:1 left hard twill and the woven fabric construction is 128 yarns of Ne 20 s/1 for warp yarn and 60 yarns of Ne 20 s/1 for weft yarn.

In one embodiment, the mix of core spun yarns to regular non-core yarns is one core spun yarn interlaced with one regular non-core yarn of similar yarn count and blend, and for every inch 64 core spun yarns and 64 regular non-core yarns are employed as warp yarns, 30 core spun yarns and 30 regular non-core yarns are employed as weft yarns.

In one embodiment, the fabric is sewn into a pair of pants, and the fabric is dyed and then finished.

Although the woven/knitted fabrics and core spun yarns disclosed in the present application are shown and described with respect to certain embodiments, it is obvious that equivalents and modifications will occur to others skilled in the art upon the reading and understanding of the specification. The present application includes all such equivalents and modifications, and is limited only by the scope of the claims.

### BRIEF DESCRIPTION OF THE DRAWINGS

Specific embodiments of the woven/knitted fabrics and core spun yarns disclosed in the present application will now be described by way of example with reference to the accompanying drawings wherein:

FIG. 1 is a cross sectional view of a core spun yarn according to an embodiment of the present application.

FIG. 2 is a perspective view of a core spun yarn with core and sheath yarns according to another embodiment of the present application.

FIG. 3 is a schematic diagram showing a weaving configuration according to one embodiment of the present application.

FIG. 4 is a schematic diagram showing a weaving configuration according to another embodiment of the present application.

### DETAILED DESCRIPTION

Reference will now be made in detail to a preferred embodiment of the woven/knitted fabrics and core spun yarns disclosed in the present application, examples of which are also provided in the following description. Exemplary embodiments of the woven/knitted fabrics and core spun yarns disclosed in the present application are described in detail, although it will be apparent to those skilled in the relevant art that some features that are not particularly important to an understanding of the woven/knitted fabrics and core spun yarns may not be shown for the sake of clarity.

Furthermore, it should be understood that the woven/knitted fabrics and core spun yarns disclosed in the present application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

As used herein, the term “core yarn” means the internal core member of a yarn, which is normally formed by core spinning. And, as used herein, the term “filament yarn” means a yarn composed of one or more filaments that extend substantially along the entire length of the yarn.

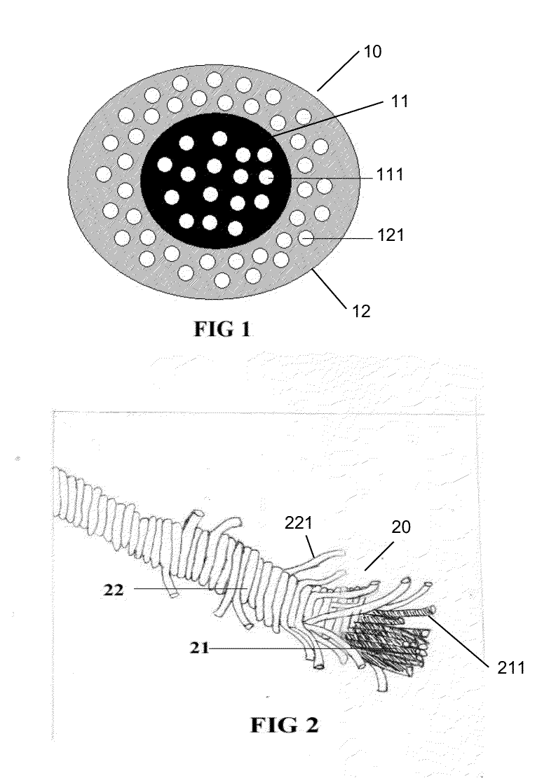

FIG. 1 is a cross sectional view of a core spun yarn 10 according to an embodiment of the present application. The core spun yarn 10 may include a core yarn 11 and a wrapper 12.

The core yarn 11 may include a core material such as polyester filament yarn, mechanical stretch polyester filament yarn, fire retardant polyester filament yarn, spandex filament yarn, high strength polyester filament yarn, nylon filament yarn, mechanical stretch nylon filament yarn, kevlar filament yarn, polypropylene filament yarn or a combination thereof. The filament yarn may include one or more filaments 111.

The selection of core material is based on the desired characteristic of the yarn. For example, if a fire retardant fabric is desired, then a fire retardant polyester filament yarn can be selected. If a high strength fabric is desired, then a high strength polyester filament yarn can be selected. If a fire retardant and high strength fabric is desired, then a combination of fire retardant polyester filament yarn and high strength polyester filament yarn can be selected.

The wrapper 12 can be wrapping around the core yarn 11. The wrapper 12 may include a wrap material such as staple fibers 121. The staple fibers 121 can be 100% cotton staple fibers, polyester cotton blended staple fibers, 100% polyester staple fibers, 100% rayon staple fibers, 100% modal staple fibers, 100% fire retardant staple fibers, polyester rayon blended staple fibers, cotton rayon blended staple fibers or a blend thereof.

FIG. 2 is a perspective view of a core spun yarn 20 according to another embodiment of the present application. This core spun yarn 20 may include a core yarn 21 and a wrapper 22. In this embodiment, the core yarn 21 may have filaments 211 that are closely packed together.

Similarly, the core yarn 21 may include a core material such as polyester filament yarn, mechanical stretch polyester filament yarn, fire retardant polyester filament yarn, spandex filament yarn, high strength polyester filament yarn, nylon filament yarn, mechanical stretch nylon filament yarn, kevlar filament yarn, polypropylene filament yarn or a combination thereof. The filament yarn may include one or more filaments 211.

Again, the wrapper 22 can be wrapping around the core yarn 21. The wrapper 22 may also include a wrap material such as staple fibers 221. The staple fibers 221 can be 100% cotton staple fibers, polyester cotton blended staple fibers, 100% polyester staple fibers, 100% rayon staple fibers, 100% modal staple fibers, 100% fire retardant staple fibers, polyester rayon blended staple fibers, cotton rayon blended staple fibers or a blend thereof.

The method of yarn production may include ring spun, open-end or vortex. Different spinning methods can produce different core sheaths such as ring spun core sheath, open-end core sheath and vortex core sheath. Ring spun, open-end and vortex spinning machines can be used to produce the yarns. A particular spinning method would yield a particular yarn characteristic leading to a particular fabric feature.

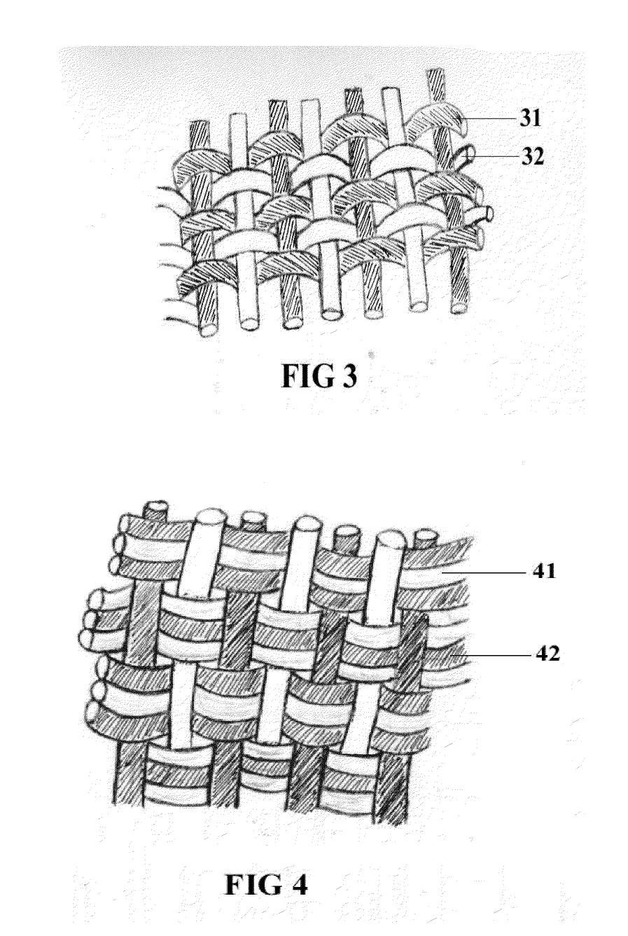

The core spun yarns 10, 20 can be formed into a woven fabric by a weaving machine. The woven fabric may have a weaving configuration such as Poplin weave, Poplin Rip stop weave (as shown in FIG. 3), left hand Twill 2:1 weave, left hand Twill 2:2 weave, left hand Twill 3:1 weave, right hand Twill 2:1 weave, right hand Twill 2:2 weave, right hand Twill 3:1 weave (as shown in FIG. 4), left hand Sateen 4:1 weave, right hand Sateen 4:1 weave, Canvas 1:1 weave, Canvas 2:2 weave, Oxford 2:2 double ply weave, Cavalry weave, Dobby weave, Jacquard weave, Corduroy weave or Flannel weave.

The core spun yarns 10, 20 can also be formed into a knitted fabric by a knitting machine. A weft knit fabric may have a weft knit configuration such as Jersey, Rib 1×1, Rib 2×1, Rib 2×2, Rib 3×3, Single Pique, Double Pique, Fleece, French Terry, Interlock, Feeder Stripe, Engineering Stripe, Dobby or Jacquard. A warp knit fabric may have a warp knit configuration such as Tricot or Rachel.

The woven and knitted fabric may include 100% core spun yarns 10, 20. The woven and knitted fabric may also include regular yarns. The proportion of core spun yarn to regular yarn may have different ratios. For example, the ratio of core spun yarn to regular yarn may be one core spun yarn to one or more regular yarns. The regular yarns can be in the form of non-core yarns or any other suitable spun yarns of simply construction. The mixing of regular yarns with core spun yarns 10, 20 of the present application can reduce the manufacturing cost of the woven and knitted fabric formed therefrom. The ratio of one core spun yarn 31, 41 to one regular yarn 32, 42 in woven fabrics is illustrated in FIGS. 3 and 4.

It is contemplated that the woven and knitted fabric of the present application can be formed into various articles of apparel such as T shirts, polo shirts, knit shirts, knit shorts, knit pants, knit jackets, woven shirts, woven pants, woven jackets, denim jeans, denim shirts, denim jackets, chambray shirts, yarn dyed shirts, yarn dyed shorts, yarn dyed pants, bed sheets and pillow cases.

In the drawings and the above description, there has been set forth an embodiment of the patent application. It is appreciated that the choices of core material, wrapping material, core spun spinning method, weaving/knitting method, core spun yarn to regular yarn ratio and apparel application are used in a generic and descriptive sense only and not for the purposes of limitation.

### EXAMPLE

In one exemplary embodiment, the fabric includes a core spun yarn wherein the core material is a polyester filament yarn of approximately 57D overall in diameter, which is constituted by 48 strands of 1.2D filaments. In this embodiment, the core spun yarn is produced by wrapping sheath fibers around the core material utilizing a ring spin core spun machine. The wrap material in this embodiment includes polyester staple fiber of 1.5D with 38 mm staple length blended with cotton fiber in a ratio of 74.1% poly/25.9% cotton. In the present embodiment the weaving method is 3:1 Left Hard Twill, and the construction of the woven fabric is 128 yarns of Ne 20 s/1 for warp yarn and 60 yarns of Ne 20 s/1 for weft yarn. In the present embodiment, the ratio of core spun yarns to regular yarns is 1 core spun yarn interlaced with 1 regular non-core spun yarn of similar yarn count and blend. Thus, for every inch 64 core spun yarns and 64 regular spun yarns are employed as warp yarns, and 30 core spun yarns and 30 non-core spun yarns are employed as weft yarns. The fabric in the present embodiment is used to sew into a pair of pants. The fabric can be dyed and finished in a normal manner.

Demonstration of Improved Tear Strength Properties

To demonstrate the improved properties in tear strength of the fabric in the present embodiment as compared to a conventional polyester and cotton blended fabric, tests of the fabrics were conducted according to a test method entitled “ASTM D1424-2009, Standard Test Method for Tearing Strength of Fabrics by Falling-Pendulum Type (Elmendorf) Apparatus”. In this test, a slit was precut at a center of a test specimen held between two clamps and the specimen was torn through a predetermined distance. The resistance to tearing was in part factored into the scale reading of the instrument and was computed from this reading and the pendulum capacity.

A fabric specimen of a core spun polyester and cotton fabric of the present embodiment was then tested. The construction of the fabrics and the results are shown in Table 1.

TABLE 1
T/C Twill 6.9 oz core spun fabric test results-compared
to Industry Standards:-

| | | Major Retailer | Test Report For | |
|---|---|---|---|---|
| | | Standard Woven > | Fabric In The Present | Com- |
| | | 7.0 Oz | Embodiment | parison |
| Tearing | Warp | 4.0 lb | 13.2 lb | 3.3 times |
| | Weft | 3.5 lb | 9.1 lb | 2.6 times |
| Tensile | Warp | 60.0 lb | 336.9 lb | 5.6 times |
| | Weft | 50.0 lb | 144.0 lb | 2.8 times |

Demonstration of Improved Tensile Strength Properties

To demonstrate the improved properties in tensile strength of the fabric in the present embodiment as compared to a conventional polyester and cotton blended fabric, tests of the fabrics were conducted according to a test method entitled “ASTM D5034-2009, Breaking Strength and Elongation of Textile Fabrics (Grab Test)”. This test is described as follows:

1. A 100-mm (4.0-in.) wide specimen was held by clamps of a tensile testing machine and force was applied until the specimen breaks. Values of breaking force and elongation of the test specimen were obtained from machine scales, dials, autographic recording charts, or a computer interfaced with the testing machine.

2. This test method describes the procedures for carrying out fabric grab tensile tests using two types of specimens and three alternative types of testing machines. For reporting, the following identification system of specific specimen and machine combinations was used.

Type of specimen:

G—Grab

MG—Modified grab

Type of tensile testing machine:

E—Constant-rate-of-extension (CRE)

L—Constant-rate-of-load (CRL)

T—Constant-rate-of-traverse (CRT)

Possible combinations can be identified as follows:

| | Type of Tester | | |
|---|---|---|---|
| | Constant-Rate- | Constant-Rate- | Constant-Rate- |
| Test Specimen | of-Extension | of-Load | of-Traverse |
| Grab | G-E | G-L | G-T |
| Modified Grab | MG-E | MG-L | MG-T |

For example, test method D 5034, G-E refers to grab test carried out on a constant rate-of-extension tensile testing machine.

These tests show that the tensile strength of the polyester and cotton core spun fabric of the present embodiment is 2.8-5.6 times more than that of the conventional polyester and cotton blend woven fabric of equal or greater weight. Also, the tearing strength of the polyester and cotton core spun fabric of the present embodiment is 2.6-3.3 times more than that of the conventional polyester and cotton blend woven fabric of equal or greater weight.

Demonstration of Improved Wrinkle Resistance Properties

To demonstrate the improved properties in wrinkle resistance of the fabric in the present embodiment as compared to a conventional polyester and cotton blended fabric, tests of the fabrics were conducted according to a test method entitled “AATCC Test Method 124-2005: Appearance of Fabrics after Repeated Home Laundering”. In this test, flat fabric specimens were subjected to standard home laundering practices. A choice was provided for hand or machine washing, alternative machine wash cycles and temperatures, and alternative drying procedures. Evaluation was performed using a standard lighting and viewing area by rating the appearance of specimens in comparison with appropriate reference standards.

A fabric specimen of a core spun polyester and cotton fabric of the present embodiment was then tested. The construction of these fabrics and the results are shown in Table 2.

TABLE 2
T/C Twill 6.9 oz core spun fabric test
results-compared to Industry Standards:

| | | Test Report for | |
|---|---|---|---|
| | | Natural and | |
| | | Permanent | |
| | | Wrinkle Resistant | |
| | | fabric in the present | |
| Major Retailer Standard | | embodiment | Remark |
| Wrinkle | 3.5 minimun | 4.0 | Natural and |
| Resistance | (With Resin) | (No Resin) | Permanent |
| (AATCC 124) | | | Wrinkle Resistant |

The test shows that the wrinkle resistance rating of the present embodiment is rated at 4.0 without application of any resin.

Demonstration of Improved Abrasion Resistance Properties

To demonstrate the improved properties in abrasion resistance of the fabric in the present embodiment as compared to a conventional polyester and cotton blended fabric, tests of the fabrics were conducted according to a test method entitled ASTM D4966-1998(2007), Option 1, “Abrasion Resistance of Textile Fabrics (Martindale Abrasion Test Method)”. This test is described as follows:

1. Abrasion resistance was measured by subjecting the specimen to rubbing motion in the form of a geometric figure, i.e., a straight line, which become a gradually widening ellipse, until it formed another straight line in the opposite direction and traced the same figure again under known conditions of pressure and abrasive action. Resistance to abrasion was evaluated by various means which are described as follow:

2. Evaluation

2.1 Option 1—The end point is reached on a woven fabric when two or more yarns have broken, or on a knitted fabric when a hole appears.

2.2 Option 2—The end point is reached when there is a change in shade or appearance that is sufficient to cause a customer to complain.

2.3 Changes of shade can arise from a variety of reasons, for example, loss of raised finish from a fabric or of boucle loops or effects from fancy yarns. Different types of yarn or fiber can cause pronounced changes in shade or appearance. In this case, the end point is assessed against the AATCC gray scale for color change.

2.4 The end point is reached when the shade change is assessed as the AATCC gray scale rating of 3 or lower.

2.5 Option 3—Determine the mass loss as the difference between the masses before and after abrasion. This loss may be expressed as a percentage of the mass before abrasion.

The fabric specimen of a core spun polyester and cotton fabric of the present embodiment was then tested. The construction of these fabrics and the results are shown in Table 3.

TABLE 3
T/C Twill 6.9 oz core spun fabric test
results-compared to Industry Standards:-

| | | Test | |
|---|---|---|---|
| | | Report for | |
| | | fabric in | |
| | Major Retailer | the present | |
| | Standard | embodiment | Comparison |
| Abrasion Resistance | 2.550 cycles | over | >27 times |
| (ASTM D4966) | Martindale | 70,000 cycle | |

This test shows that the abrasion resistance of the polyester and cotton core spun yarn fabric of the present embodiment is 27 times greater than that of the conventional polyester and cotton blend yarn woven fabric of equal or greater weight.

While the woven/knitted fabrics and core spun yarns disclosed in the present application have been shown and described with particular references to a number of preferred embodiments thereof, it should be noted that various other changes or modifications may be made without departing from the scope of the appending claims.

What is claimed is:

1. A core spun yarn comprising:
(a) a core yarn comprising a core material selected from the group consisting of polyester filament yarn, mechanical stretch polyester filament yarn, fire retardant polyester filament yarn, spandex filament yarn, high strength polyester filament yarn, nylon filament yarn, mechanical stretch nylon filament yarn, kevlar filament yarn, polypropylene filament yarn and combinations thereof; and
(b) a wrapper wrapping around the core yarn and comprising a wrap material selected from the group consisting of 100% cotton staple fibers, polyester cotton blended staple fibers, 100% polyester staple fibers, 100% rayon staple fibers, 100% modal staple fibers, 100% fire retardant staple fibers, polyester rayon blended staple fibers and cotton rayon blended staple fibers and blends thereof.

2. A fabric comprising the core spun yarn as claimed in claim 1.

3. The fabric as claimed in claim 2, further comprising a regular non-core yarn, wherein the fabric is formed with a mixture of the core spun yarns and the regular non-core yarns.

4. The fabric as claimed in claim 3, wherein the ratio of core spun yarns to regular non-core yarns is one core spun yarn to one or more regular non-core yarns.

5. The fabric as claimed in claim 2, comprising a weaving configuration selected from the group consisting of poplin weave, poplin rip stop weave, left hand twill 2:1 weave, left hand twill 2:2 weave, left hand twill 3:1 weave, right hand twill 2:1 weave, right hand twill 2:2 weave, right hand twill 3:1 weave, left hand sateen 4:1 weave, right hand sateen 4:1 weave, canvas 1:1 weave, canvas 2:2 weave, oxford 2:2 double ply weave, cavalry weave, dobby weave, jacquard weave, corduroy weave and flannel weave.

6. The fabric as claimed in claim 2, comprising a weft knit configuration selected from the group consisting of jersey, rib 1×1, rib 2×1, rib 2×2, rib 3×3, single pique, double pique, fleece, French terry, interlock, feeder stripe, engineering stripe, dobby and jacquard.

7. The fabric as claimed in claim 2, comprising a warp knit configuration selected from the group consisting of tricot and rachel.

8. The fabric as claimed in claim 2, wherein the fabric is produced by core spun yarns formed by a core sheath selected from the group consisting of ring spun core sheath, open-end core sheath or vortex core sheath.

9. An article of apparel made of the fabric of claim 2.

10. The article of apparel as claimed in claim 9, wherein the article of apparel is selected from T shirts, polo shirts, knit shirts, knit shorts, knit pants, knit jackets, woven shirts, woven pants, woven jackets, denim jeans, denim shirts, denim jackets, chambray shirts, yarn dyed shirts, yarn dyed shorts, yarn dyed pants, bed sheets and pillow cases.

11. The fabric as claimed in claim 2, wherein the core material comprises polyester filament yarn of approximately 57D overall in diameter, constituted by 48 strands of 1.2D filaments.

12. The fabric as claimed in claim 2, wherein the core spun yarn is produced by wrapping the wrap material around the core material utilizing a ring spin core spun machine.

13. The fabric as claimed in claim 2, wherein the wrap material comprises polyester staple fiber of 1.5D with 38 mm staple length blended with cotton fiber in a ratio of 74.1% poly/25.9% cotton.

14. The fabric as claimed in claim 2, comprising a weaving configuration of 3:1 left hard twill and a woven fabric construction of 128 yarns of Ne 20 s/1 for warp yarn and 60 yarns of Ne 20 s/1 for weft yarn.

15. The fabric as claimed in claim 3, wherein the mix of core spun yarns to regular non-core yarns is one core spun yarn interlaced with one regular non-core yarn of similar yarn count and blend, and for every inch 64 core spun yarns and 64 regular non-core yarns are employed as warp yarns, 30 core spun yarns and 30 regular non-core yarns are employed as weft yarns.

16. The fabric as claimed in claim 2, wherein the fabric is sewn into a pair of pants, and the fabric is dyed and then finished.
